(19) United States
(12) Patent Application Publication
(10) Pub. No.: US 2011/0157011 A1
(43) Pub. Date: Jun. 30, 2011

(54) USER-OPERATED DIRECTIONAL CONTROLLER FOR AN ELECTRONIC DEVICE

(75) Inventor: Robert Kelley, Portland, OR (US)

(73) Assignee: OQO, Inc., San Francisco, CA (US)

(21) Appl. No.: 12/348,820

(22) Filed: Jan. 5, 2009

Related U.S. Application Data
(60) Provisional application No. 61/019,160, filed on Jan. 4, 2008.

(51) Int. Cl. G06F 3/033

(52) U.S. Cl. 345/157

(57) ABSTRACT

Embodiments of the invention provide a user-operated directional controller for an electronic device. One embodiment provides an apparatus that includes a pointing device which receives raw signal data in an electronic device, one or more processors, and logic encoded in one or more tangible media for execution by the one or more processors and when executed operable to: determine a first coordinate value for a cursor position by reading x, y coordinate values from a directional controller; determine a remainder value associated with the first coordinate value; store the remainder value; determine a second coordinate value for a second cursor position by reading x, y coordinates from the directional controller; compute the second coordinate value by using a residual value, wherein the residual value is derived from the stored remainder value from a previous calibration operation; and store the subsequent remainder value.

### REFERENCE TO RELATED APPLICATIONS

This application claims the benefit of the following provisional patent application which is hereby incorporated by reference as if set forth in full in this specification for all purposes: U.S. Patent Application Ser. No. 61/019,160 entitled “USER-OPERATED DIRECTIONAL CONTROLLER FOR AN ELECTRONIC DEVICE,” filed on Jan. 4, 2008, (Attorney docket numbers 100127-002700US and OQO/USR0606S).

### BACKGROUND

Directional controllers are commonly used in computer processing devices such as personal computers, laptops, ultra-portables, cell phones, etc. A directional controller allows a user of a device to move a pointer on a display screen to manipulate objects, make menu selections, initiate functions or perform other operations. Examples of directional controllers include a pointing stick, touch pad, touch screen, mouse, trackball, joystick, etc. Small controllers such as a pointing stick or touchpad have become popular for use with small portable computing devices, such as handheld computers, cell phones, or the like.

The effectiveness of a directional controller is largely dependent upon the sensitivity, consistency, and overall performance. In order to make a directional controller's performance acceptable to a user, it is usually necessary to perform corrections or to otherwise compensate or calibrate a directional controller for undesirable physical effects such as drift, noise, thermal or other environmental effects, etc. Also, a directional controller should adapt to different users' habits such as the speed of movement, frequency or force of presses (i.e., “click” detection), and other factors which may vary over time even for the same user.

### SUMMARY

Embodiments of the invention provide a user-operated directional controller for an electronic device. One embodiment provides an apparatus that includes a pointing device which receives raw signal data in an electronic device, one or more processors, and logic encoded in one or more tangible media for execution by the one or more processors and when executed operable to: determine a first coordinate value for a cursor position by reading x, y coordinate values from a directional controller; determine a remainder value associated with the first coordinate value; store the remainder value; determine a second coordinate value for a second cursor position by reading x, y coordinates from the directional controller; compute the second coordinate value by using a residual value, wherein the residual value is derived from the stored remainder value from a previous calibration operation; and store the subsequent remainder value.

### BRIEF DESCRIPTION OF THE DRAWINGS

FIG. 1 shows an example of a handheld computing device with a user-operated directional controller.

FIG. 2 illustrates axes of operation of the directional controller of FIG. 1.

FIG. 3A shows a block diagram of subsystems in the handheld computing device of FIG. 1 in accordance with one embodiment.

FIG. 3B shows a block diagram of subsystems in the handheld computing device of FIG. 1 in accordance with another embodiment.

FIG. 4 shows a flowchart that illustrates basic steps to achieve some of the functionality described herein.

FIG. 5 shows a flowchart that illustrates basic steps to achieve some of the functionality described herein.

FIG. 6 shows a flowchart that illustrates basic steps to achieve some of the functionality described herein.

### DETAILED DESCRIPTION OF THE INVENTION

### Definitions

Coordinate values may include an n-tuple of numbers or scalars, where each component of a given tuple corresponds to a point in an n-dimensional space. Embodiments of the present invention may be applied to various different types of coordinate systems, depending on the specific application. Such coordinate systems may include but are not limited to, for example, a Cartesian coordinate system, a polar coordinate system, curvilinear coordinate system, etc.

Drift is the motion of a cursor that occurs even when no user is moving the pointing device.

A human cursor movement threshold may be defined as a point or value at which the movement of a cursor is deemed to be caused by a user. For example, if changes in the position of a cursor meet a predetermined human cursor movement threshold, the movement is deemed to be caused by a user. Otherwise, if the predetermined human cursor movement threshold is not met, the movement is deemed to be caused by something other than a user (e.g., drift, correction operation, etc.).

A pointing device is an input interface that enables a user to input spatial data into a computer to control the position or movement of a pointer in the display. For example, a pointing device may include a pressure-responsive directional controller device such as a track stick, joystick, etc. A pressure-responsive directional controller device requires sensing a human exerting a force on a fixed physical structure. This is different from, for example, devices such as a mouse (optical or mechanical), trackball, etc.

Quantization is an operation that converts a set of more continuous values to a set of less continuous, or discrete, values, referred to as quantization values. For example, real numbers may be quantized to integers. A first set of integers can be quantized to a second set of integers where the second set of integers has coarser values than the first set. A quantization process may produce quantization values and corresponding residual values.

A sample is one or more readings from a set of values. For example, a sample may include one or more coordinate values of a pointer position (e.g., x, y coordinate values).

Description

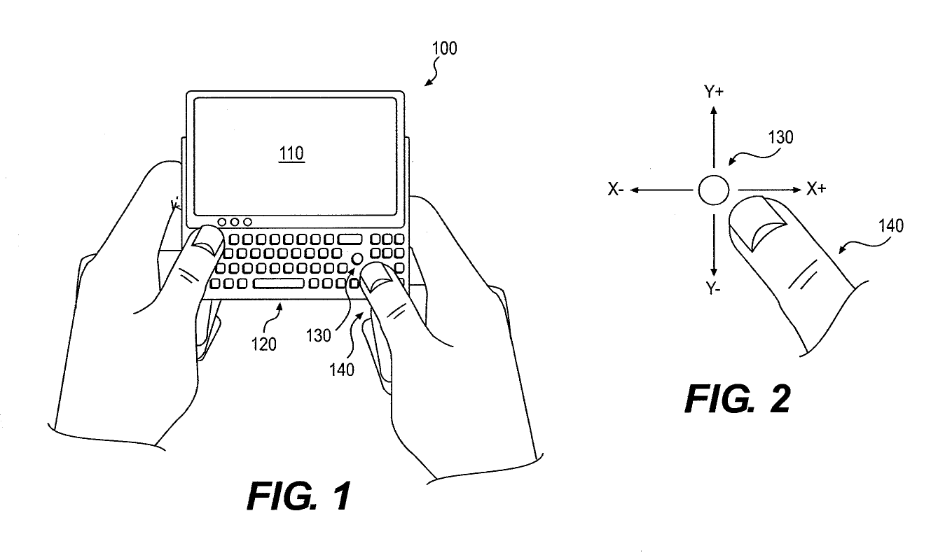

FIG. 1 shows an example of a handheld computing device with a user-operated directional controller. In FIG. 1, device 100 includes a display 110, a keyboard 120, and a directional controller 130 such as a track stick. Discussion of other controls and features of the device are omitted. The device in FIG. 1 corresponds generally to a type of consumer product referred to as an “ultra-portable mobile computer” (UPMC) such as that manufactured and sold by OQO™, Inc. It should be apparent that embodiments of the invention may be applied to many different types of electronic devices other than the specific device shown in FIG. 1. For example, any device that is provided with substantial controls may benefit from features described herein.

As shown in FIG. 1, the device is typically held in the user's hands, and the directional controller 130 is operated by one of the user's digits, such as a thumb 140. However, other devices may use other modes of operation of the directional controller, as desired.

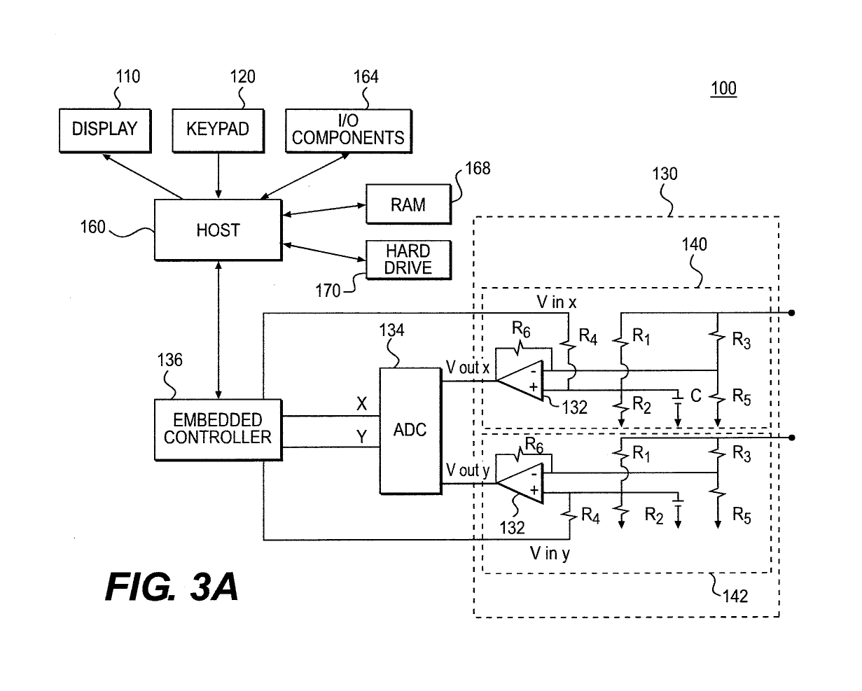

FIG. 2 illustrates axes of operation of the directional controller of FIG. 1. FIG. 2 includes an enlarged view about the region of directional controller 130 of FIG. 1. In general, items with identical numbering among two or more different figures are used to denote the same item. Thus, in FIG. 2, thumb 140 is used to push directional controller 130 along either or both of X and Y coordinate axes in the directions of X−, X+, Y− and Y+, as is known in the art. The application of pressure to the directional controller 130 is translated into x and/or y movement of a pointer, cursor, selection box, content within a window, or is used to produce an effect so that the user can operate or control device 100, or perform functions associated with the device.

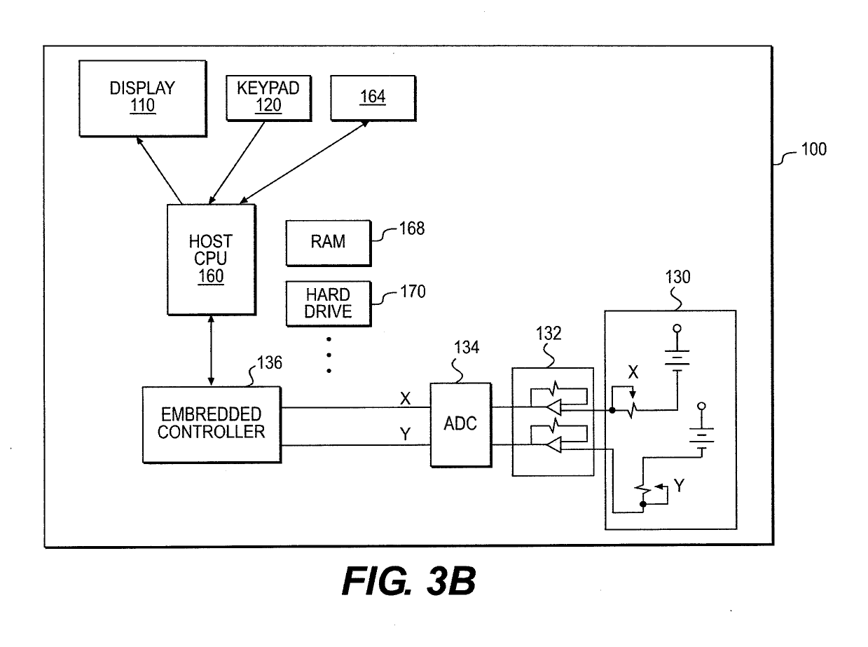

FIG. 3A shows a block diagram of subsystems in the handheld computing device 100 of FIG. 1 in accordance with one embodiment. In FIG. 3A, device 100 includes a host central processing unit (CPU) or “processor” 160 that can variously receive or send information to subcomponents or subsystems such as display 110, keyboard 120, or other user input/output components 164. Processor 160 may have system resources such as random-access memory (RAM) 168, a hard drive 170, etc. Processor 160 may also represent multiple processors and may execute logic encoded in one or more tangible media to perform operations described herein. Embedded controller 136 is in communication with processor 160, but is typically provided with its own internal system resources (not shown).

In one embodiment, embedded controller 136 receives x and y coordinate values that correspond to pressure that a user applies to directional controller 130. In one embodiment, directional controller 130 receives raw signal data based on input from the user and sends the raw signal data to analog-to-digital converter (ADC) 134, which converts the raw signal data to x and y coordinate values (digital data), and sends the x and y coordinate values to embedded controller 136. Embedded controller 136 sends the x and y coordinate values to the processor 160, which then moves a cursor shown on display 110 based on the x and y coordinate values.

In one embodiment, directional controller 130 includes an x-channel 140 and a y-channel 142. The x-channel 140 and a y-channel 142 each include a differential amplifier 132, a network of resistors R1-R6, and a capacitor C. In one embodiment, the gain of each amplifier 132 is R6/R4, where R1=R2, R3>>R1, R4≈R5, and R6>>R4. In one embodiment, resistors R4 and R5 are variable resistors. In one embodiment, resistors R4 and R5 are strain gauge resistors.

Other embodiments of the directional controller are possible. For example, the directional controller may include R4 and R5, where the remaining resistors R1, R2, R3, and R6, and capacitor C may be a part of an intermediary circuit.

The embedded controller 136 provides a reference voltage to one of the inputs to each of the amplifiers 132 via resistors R1-R6; and the other of the inputs to each of the amplifiers 132 is controlled by the raw signal data based on input from the user. In one embodiment, the embedded controller 136 provides a single reference voltage to both amplifiers 132. In another embodiment, the embedded controller 136 may provide two separate reference voltages, one for each of the amplifiers 132. In one embodiment, the embedded controller 136 includes a digital-to-analog converter (DAC) to drive Vin. In another embodiment, the embedded controller 136 includes a pulse-width modulated output that to drives Vin through a low-pass filter.

In one embodiment, for each amplifier 132, Vin (i.e., Vinx or Viny) is initially at the midpoint between the V+ input and ground. If embedded controller 136 detects that Vout (i.e., Voutx or Vouty) is above the midpoint, the embedded controller 136 reduces Vin in order to bring Vout to the midpoint, or as close to the midpoint as possible. In one embodiment, embedded controller 136 performs a binary search adjust Vin in order to bring Vout to the midpoint, or as close as possible to the midpoint. As such, each amplifier is automatically nulled by embedded controller 136. In one embodiment, this nulling operation is performed during initialization of the handheld computing device 100. In other embodiments, as described in more detail below, this nulling operation may also be performed during a drift correction operation.

As indicated above, the amplified x, y signals are provided to ADC 134, which also serves to track and update a location of a virtual pointer. Thus, the analog signal inputs to ADC 134 represent pressure applied in the x and y directions. ADC 134 converts the analog signal inputs to digital coordinates of a current x, y screen position of a pointer.

FIG. 3B shows a block diagram of subsystems in the handheld computing device 100 of FIG. 1 in accordance with another embodiment. The handheld computing device 100 is similar to that of FIG. 3A except that the handheld computing device 100 includes a directional controller 133 instead of the directional controller 130. In a specific embodiment, the directional controller is illustrated in symbolic form as a pair of variable resistances through which a voltage is applied to amplifiers 132.

In one embodiment, processor 160 determines an operating point by performing a binary search to converge on a null value at a predefined time (e.g., upon system power-up, when a lid of the electronic device is lifted, etc.).

Note that FIG. 3 illustrates main components of one approach to a system that is suitable for implementing embodiments of the invention. In other approaches, different components may be used. Components may be added to, taken away from, or used in place of those shown in FIG. 3. For example, a different system could provide x and y values output from ADC 134 that are indicative of the pressure applied to the x and y directions, respectively, rather than absolute coordinates of the pointer's x, y location. In other approaches, the signal outputs from directional controller 130 could be provided directly to embedded controller 136, assuming that directional controller 136 would perform signal processing, analog-to-digital conversion, and other functions in order to obtain data sufficient for the processing described below. Many arrangements and selections of components and designs are possible.

The circuits illustrated in amplifiers 132 are symbolic and not intended to represent an actual circuit. Any manner of amplification, conditioning or signal processing may be employed, as desired.

Embodiments of the invention include the following:

Smoothing Operation

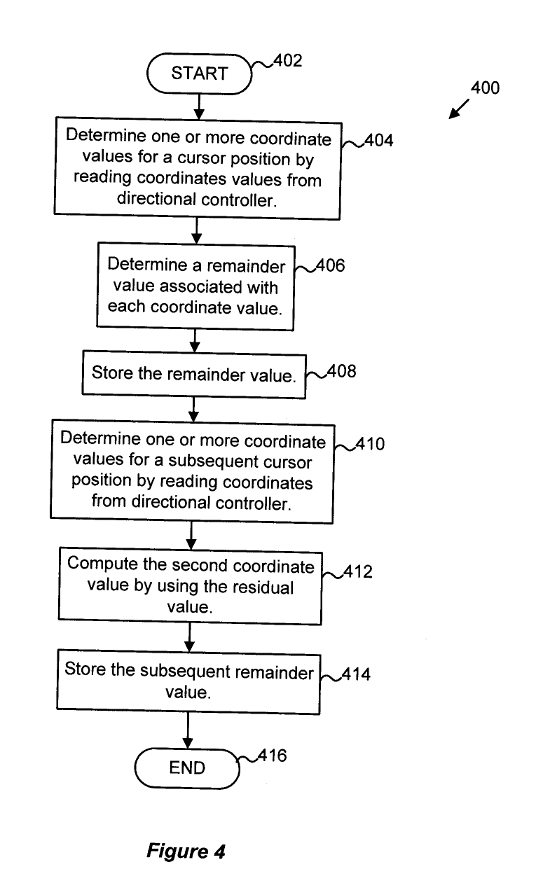

FIG. 4 shows a flowchart that illustrates basic steps to achieve some of the functionality described herein. In FIG. 4, flowchart 400 is entered at step 402 when a user moves directional controller 130, at which point the directional controller 130 receives input (e.g., applied pressure) from a user. This input results in a change in Vₒᵤₜₓ and/or V_{outy} of the directional controller 130. At step 404, processor 160 determines one or more coordinate values for a cursor position by reading coordinate values from directional controller 130. In one embodiment, the coordinates are x, y coordinates and include x-axis values and y-axis values. In one embodiment, processor 160 receives the coordinate values from the directional controller 130 via ADC 134 and embedded controller 136. Processor 160 may derive coordinate values from the output values immediately or after storing the output values in a memory (e.g., RAM 168).

At step 406, processor 160 determines a remainder value associated with each coordinate value. In one embodiment, to determine remainder values, processor 160 performs a quantization operation on each of the coordinate values to generate a coordinate value (i.e., quantization value) and a corresponding residual value. In particular embodiments, a remainder value is derived from a residual value resulting from a quantization operation. For example, a remainder value may be a multiplier (e.g., 0.5) of a particular residual value.

In one embodiment, processor 160 may compute a frequency of movement of a given coordinate value. If the frequency of movement is greater than a predefined value, processor 160 may remove a portion of the coordinate value from a calculation of a new pointer position based on the frequency of movement.

At step 408, processor 160 stores the remainder value. In one embodiment, processor 160 discards (or alternatively stores) any remaining portion of the residual value (e.g., that is not stored as a part of the remainder value). In one embodiment, the portion of the residual value that is discarded is between 17% and 37%. In other embodiments, different proportions may be used to achieve a desired behavior of the system. In one embodiment, remainder values are initialized to zero before a first calibration operation.

At step 410, processor 160 determines one or more coordinate values for a subsequent cursor position by reading coordinates (e.g., x, y coordinates) from directional controller 130. At step 412, the processor 160 computes the second coordinate value by using the residual value. In one embodiment, processor 160 computes the second coordinate value by adding the residual value to the determined coordinate value. In one embodiment, the computation results in a subsequent remainder value. For example, in one embodiment, the computed second coordinate value may be quantized, which would result in a quantized second coordinate value (e.g., an integer) and the resulting subsequent remainder value.

At step 414, processor 160 stores the subsequent remainder value. In one embodiment, the subsequent remainder value is used in a future calibration operation (e.g., the next calibration operation). The routine exits at step 416. In one embodiment, processor 160 stores the coordinate values in a memory (e.g., RAM 168). The coordinate values may then be used to influence cursor movement.

Drift Correction for a User-Operated Directional Controller

In one embodiment, processor 160 may execute a drift correction operation to prevent the cursor from drifting when the user does not intend to move the cursor (e.g., when the user is not applying any pressure on directional controller 130). A drift correction operation that is erroneously applied causes the cursor position to move even when a user is not moving the directional controller. The following embodiments prevent erroneous application of the drift correction operation.

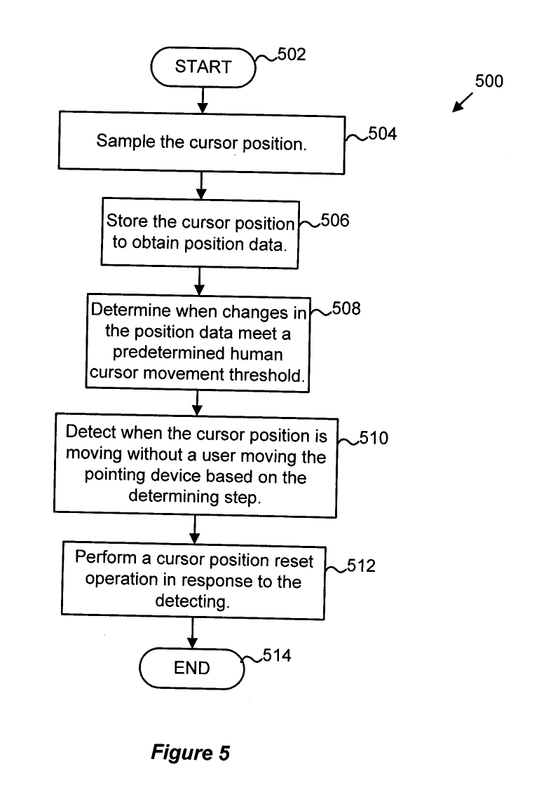

FIG. 5 shows a flowchart that illustrates basic steps to achieve some of the functionality described herein. In FIG. 5, flowchart 500 is entered at step 502 at system power-up or when a user releases the directional controller 130. At step 504, processor 160 samples the cursor position. In one embodiment, processor 160 performs the sampling by reading one or more coordinate values associated with the position of the cursor. At step 506, processor 160 stores the cursor position to obtain position data. Processor 160 iteratively repeats the sampling and storing operations.

At step 508, processor 160 determines when changes in the position data meet a predetermined human cursor movement threshold. In one embodiment, the human cursor movement threshold may be based on variations in the rate that the coordinate values change. For example, when the rate of change from sample-to-sample does not vary, or varies by just a little, such a steady force application may be deemed to be impossible or implausible for a human user. The human cursor movement threshold may not be met if such constant or low variations are present.

At step 510, processor 160 detects when the cursor position is moving without a user moving the pointing device, based on the determining operation. For example, if the cursor position is changing at a constant rate for a predefined period of time, the cursor movement may be deemed to be not caused by a user (e.g., caused by drift). In a more specific embodiment, after receiving samples of coordinate values for the cursor position, processor 160 may determine the magnitude values for coordinate values. If the magnitude values remain constant for a predefined period of time, the cursor position is deemed to be moving without a user moving the pointing device.

In alternative embodiments, the human cursor movement threshold may be based on other metrics such as velocity (e.g., constant velocity=non-human cause) or acceleration (e.g., zero acceleration=non-human cause).

At step 512, processor 160 performs a cursor position reset operation in response to the detecting operation. In one embodiment, to perform a cursor position reset operation, processor 160 nulls the coordinate values; and the cursor position reset operation is performed if the cursor position is deemed to be moving without a user moving the pointing device. In one embodiment, processor 160 disables the cursor position reset operation (or drift correction operation) when the cursor position moves without a user moving the pointing device. The routine exits at step 514.

Detection of User-Initiated Cursor Movement

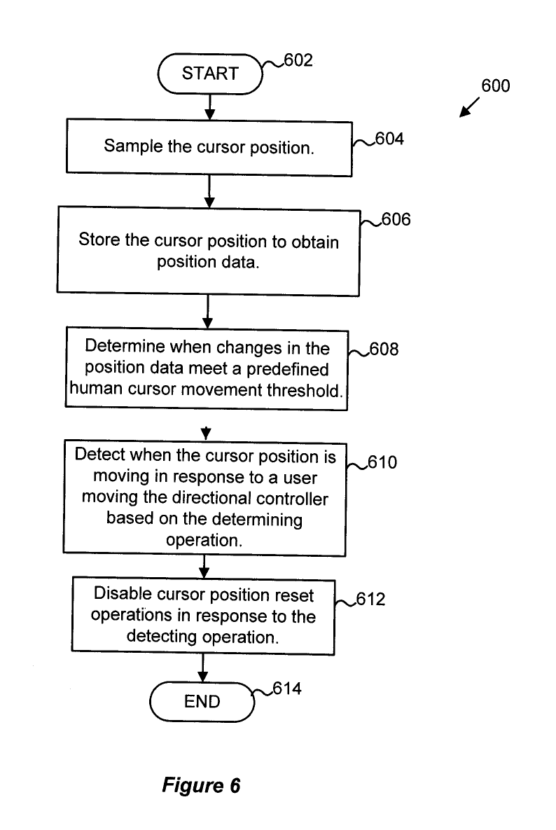

FIG. 6 shows a flowchart that illustrates basic steps to achieve some of the functionality described herein. In FIG. 6, flowchart 600 is entered at step 602 at system power-up. At step 604, processor 160 samples the cursor position. At step 606, processor 160 stores the cursor position to obtain position data. In one embodiment, processor 160 iteratively repeats the sampling and storing cursor operations.

At step 608, processor 160 determines when changes in the position data meet a predefined human cursor movement threshold. As described above, if the changes in the position data meet a predefined human cursor movement threshold, the changes are deemed to be caused by a user. If the cursor movement (i.e., changes in the position data) is deemed to be caused by a user, the processor 160 disables any drift correction operations.

In one embodiment, the predefined human cursor movement threshold is based on differences between adjacent samples of coordinate values. For example, the predefined human cursor movement threshold may be any measured differences between adjacent samples of coordinate values. For example, changes in the position data meet a predefined human cursor movement threshold when processor 160 measures differences between absolute values of adjacent samples of the coordinate values. In other words, the existence of differences between absolute values of adjacent samples of the coordinate values indicates that a user is causing the changes in the cursor position by the user moving the directional controller.

In one embodiment, the predefined human cursor movement threshold may be a predefined absolute value. For example, a predefined human cursor movement threshold may be met if processor 160 measures an absolute value of at least one of the coordinate values, compares it to the predefined human cursor movement threshold, and determines that the measured absolute value is equal to or greater than the predefined human cursor movement threshold. In other words, a measure absolute value being equal to or greater than the predefined human cursor movement threshold indicates that a user is causing the changes in the cursor position by the user moving the directional controller.

At step 610, processor 160 detects when the cursor position is moving in response to a user moving the directional controller 130 (e.g., pointing device), based on the determining operation above. In particular embodiments, if the human cursor movement threshold is met, the cursor is deemed to be caused by a user moving the pointing device. At step 612, processor 160 disables cursor position reset operations in response to the detecting operation. In one embodiment, processor 160 applies a cursor position reset operation to the coordinate values when a user is not moving the pointing device in order to cause the coordinate values to equal zero. The routine exits at step 614.

Source code shown in Table I, below, provides details by which track stick calibration and control is performed in a particular embodiment. Instructions represented by the source code are executed by embedded controller 136 and the results of the pointer x, y updated position and behavior are provided to host CPU 160 so that the host CPU can invoke functions based on the user's manipulation of an onscreen pointer or other selection mechanism. Note that this example includes diagnostic statements such as the “printf” statements that would not normally be included in a consumer product.

```
[BEGIN - SOURCE CODE TABLE I]
//
// tasks/trackstick.cc
//
// Copyright (C) 2005-2007 OQO, Inc.
//
// Authors: robert kelley <pasha@ocio.com>
//
// Trackstick driver
#include <config.hh>
#include <pin.hh>
#include <core/task.hh>
#include <core/timer.hh>
#include <core/sched.hh>
#include <tasks/keyboard.hh>
#include <tasks/trackstick.hh>
#include <config.hh>
#include <arch/at91.hh>
#include <pin.hh>
#include <drivers/adc.hh>
#include <drivers/at91pwm.hh>
#include <core/journal.hh>
#include <tasks/hid.hh>
#include <tasks/sink.hh>
extern “C” unsigned int isqrt(unsigned int x);
namespace Tasks
{
    class Trackstick : public Core::Task
    {
```

| | |
|---|---|
| int | oversample; |
| int | x1, y1, xr, yr, x, y; |
| int | xl, xh, trackstickXin; |
| int | yl, yh, trackstickYin; |
| int | trackstickXout; |
| int | trackstickYout; |
| int | noisyCount; |
| int | quietCount; |

| | |
|---|---|
| unsigned char | buttons; |

| | |
|---|---|
| bool | mouseEvent; |

| | |
|---|---|
| bool | nulling; |

public:

| | |
|---|---|
| virtual void | init(void); |
| virtual void | handler(void); |
| bool | doSample(void); |
| void | trackstickOn(void); |
| void | trackstickOff(void); |
| void | dump(void) const; |
| inline bool | eventPending(void) const { return mouseEvent; } |
| inline bool | isOn(void) const { return sensor_en && !nulling; } |
| inline bool | isNulling(void) const { return sensor_en && nulling; } |

| | |
|---|---|
| inline void | buttonAction(int whichButton, KeyAction keyAction) |

```
                    {
                      if (KEY_DOWN ==keyAction)
                        buttons |= (1<<whichButton);
                      else
                        buttons &= ~(1<<whichButton);
                      mouseEvent = true;
                    }
    };
  extern Trackstick trackstick;
}
/*
* turn the trackstick on
*/
void Tasks::Trackstick::trackstickOn(void)
{
    nulling = true;
    sensor_en = true;
    xl = yl = 0;
    xh = yh = CLOCK_FREQUENCY/PCM_FREQUENCY/2;
    trackstickXout = trackstickYout = 0;
}
/*
* turn the trackstick off
*/
void Tasks::Trackstick::trackstickOff(void)
{
    sensor_en = false;
}
/*
* dump member variables
*/
void Tasks::Trackstick::dump(void) const
{
    printf(“oversample %d\n”, oversample);
    printf(“x1 %d y1 %d xr %d yr %d x %d y %d trackstickXin %d trackstickYin
%d trackstickXout %d trackstickYout %d\n”,
      x1, y1, xr, yr, x, y, trackstickXin, trackstickYin, trackstickXout,
trackstickYout);
    printf(“buttons %02x mouseEvent %d noisyCount %d quietCount %d\n”,
      buttons, mouseEvent, noisyCount, quietCount);
}
/*
* sample the trackstick
*/
bool Tasks::Trackstick::doSample(void)
{
    bool result = false;
    if (nulling) {
              if (journalData->featureControl0 &
(1<<FC0_TRACKSTICK_NULL_LOGGING))
                putchar(‘\n’);
              while (xl <= xh || yl <= yh)
              {
                Drivers::pwm.setTrackOffsetXPWM(trackstickXin = (xl + xh) / 2);
                Drivers::pwm.setTrackOffsetYPWM(trackstickYin = (yl + yh) / 2);
                x = y = 0;
                waitTicks(Drivers::At91Timer::ticks10ms);
                for (oversample = journalData->trackstickOversample;
oversample; --oversample)
                {
                  x = Drivers::adc.read(Drivers::adc.TRACK_XO) − 512;
                  y = Drivers::adc.read(Drivers::adc.TRACK_YO) − 512;
                  Core::sched.yield( );
                }
                if (journalData->featureControl0 &
(1<<FC0_TRACKSTICK_NULL_LOGGING))
                  printf(“(%d, %d):(%d, %d) ”, trackstickXin, trackstickYin,
x, y);
                if (x > 0)
                  xh = trackstickXin−1;
                else if (x < 0)
                  xl = trackstickXin+1;
                if (y > 0)
                  yh = trackstickYin−1;
                else if (y < 0)
                  yl = trackstickYin+1;
              }
              trackstickXout = x << 6;
              trackstickYout = y << 6;
              if (journalData->featureControl0 &
(1<<FC0_TRACKSTICK_NULL_LOGGING))
                printf(“(%d, %d):(%d, %d) ”, trackstickXin, trackstickYin, x, y);
              Drivers::pwm.playVerbose(journalData->recalibrateSound);
              oversample = journalData->trackstickOversample;
              nulling = false;
              return result;
    } else if (oversample) {
              x += Drivers::adc.read(Drivers::adc.TRACK_XO) − 512;
              y += Drivers::adc.read(Drivers::adc.TRACK_YO) − 512;
              --oversample;
              return result;
    } else {
              int th = journalData->trackstickSquelch * journalData-
>trackstickOversample;
              int jitter = isqrt((x1−x)*(x1−x)+(y1−y)*(y1−y));
              x1 = x;
              y1 = y;
              x = (trackstickXout >> 6) − x;
              y = (trackstickYout >> 6) − y;
              if (journalData->featureControl0 &
(1<<FC0_TRACKSTICK_ADC_LOGGING))
                printf(“\n%5d %5d (%3d, %3d) ”, x, y, jitter, th);
              if (jitter <journalData->trackstickThreshold)
              {
                if (−th < x && x < th && −th < y && y < th)
                {
                  noisyCount = 0;
                  if (journalData->featureControl0 &
(1<<FC0_TRACKSTICK_ADC_LOGGING))
                            printf(“! ”);
                  if (x > 0)
                    trackstickXout −= journalData->trackstickNullRate;
                  else if (x < 0)
                    trackstickXout += journalData->trackstickNullRate;
                  if (y > 0)
                    trackstickYout −= journalData->trackstickNullRate;
                  else if (y < 0)
                    trackstickYout += journalData->trackstickNullRate;
                }else if (++noisyCount == journalData->trackstickNoisy)
                  trackstickOn();
              }
              // add some portion of the remainder from the last sample
              x += xr − xr * journalData->trackstickStiction / 256;
              y += yr − yr * journalData->trackstickStiction / 256;
              // remember old x and y (renaming would help!)
              int xp = x, yp = y;
              // determine acceleration
              int d = isqrt(x*x+y*y);
              if (d > 1024) d = 1024;
              // determine multiplier
              int dg = d * journalData->trackstickGain;
              // calculate output values
              x = (x * dg) / (1 << 19);
              y = (y * dg) / (1 << 19);
              // calculate remainders
              xr = xp − x* (1 << 19) / dg;
              yr = yp − y* (1 << 19) / dg;
              if (quietCount) {
                if (x == 0 && y == 0)
                  --quietCount;
                else
                  trackstickOn( );
              }else if (mouseEvent || x || y) {
                if (journalData->featureControl0 &
(1<<FC0_TRACKSTICK_DATA_LOGGING))
                  printf(“\n[ %d %d %x ] ”, x, y, buttons);
                hid.mouse(x, −y, buttons);
                x = y = 0;
                mouseEvent = false;
                result = true;
              }
    }
    x = y = 0;
    oversample = journalData->trackstickOversample;
    return result;
}
void Tasks::Trackstick::init(void)
{
    Task::init( );
    setStackSize(0×148);
    setLatency(Drivers::At91Timer::ticks100us);
    setInterval(Drivers::At91Timer::ticks312us);
    setName(“trackstick”);
    mouse Event = false;
    buttons = 0;
}
void Tasks::Trackstick::handler(void)
{
    for (;; ++counter)
    {
      if (((PM_STATE_RUNNING == Tasks::sink.getPMState( ))
            && (journalData->featureControl0 & (1<<FC0_TRACKSTICK_ENABLE))
            && sensor_en)
          || (journalData->featureControl1 & (1 << FC1_FORCE_TRACKSTICK)))
        doSample( );
      Core::sched.yield( );
    }
}
[END TABLE I]
```

Although specific embodiments of the invention have been described, variations of such embodiments are possible and are within the scope of the invention.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain and store the program for use by or in connection with the instruction execution system, apparatus, system or device. The computer readable medium can be, by way of example only but not by limitation, a semiconductor system, apparatus, system, device, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. An apparatus comprising:
a pointing device which receives raw signal data in an electronic device;
one or more processors; and
logic encoded in one or more tangible media for execution by the one or more processors and when executed operable to:
determine a first coordinate value for a cursor position by reading x, y coordinate values from a directional controller;
determine a remainder value associated with the first coordinate value;
store the remainder value;
determine a second coordinate value for a second cursor position by reading x, y coordinates from the directional controller;
compute the second coordinate value by using a residual value, wherein the residual value is derived from the stored remainder value from a previous calibration operation; and
store the subsequent remainder value.

2. The apparatus of claim 1 wherein, to determine the remainder value, the one or more processors are operable to quantize the first coordinate value to generate a quantized coordinate value and the remainder value.

3. The apparatus of claim 1 wherein the remainder value is derived from an integer division on an input from the directional controller.

4. The apparatus of claim 1 wherein the first and second coordinate values are received from a directional controller.

5. The apparatus of claim 1 wherein the one or more processors performs a quantization operation on each of the coordinate values to generate a coordinate value and a corresponding residual value.

6. The apparatus of claim 1 wherein the one or more processors performs a quantization operation on each of the coordinate values to generate a coordinate value and a corresponding residual value, and wherein the resulting coordinate value is an integer.

7. The apparatus of claim 1 wherein the remainder value is derived from the residual value resulting from quantization operation.

8. The apparatus of claim 1 wherein the remainder value is a multiplier of a residual value resulting from quantization operation.

9. The apparatus of claim 1 wherein the remainder value is derived from the residual value resulting from quantization operation, and wherein the one or more processors discards any portion of the residual value that is not stored as a remainder value.

10. The apparatus of claim 1 wherein the remainder value is derived from the residual value resulting from quantization operation, wherein the one or more processors discards any portion of the residual value that is not stored as a remainder value, and wherein the portion of the residual value that is discarded is between 17% and 37%.

11. The apparatus of claim 1 further comprising:
a controller coupled to the one or more processors; and
an analog-to-digital converter coupled to the controller and to the directional controller.

12. The apparatus of claim 1 wherein the directional controller comprises:
a plurality of differential amplifiers; and
a plurality of resistors coupled to the differential amplifiers.

13. An apparatus comprising:
a pointing device;
one or more processors; and
logic encoded in one or more tangible media for execution by the one or more processors and when executed operable to:
sample a cursor position;
store the cursor position to obtain position data;
iteratively repeat the sampling and storing cursor operations;
determine when changes in the position data meet a predetermined human cursor movement threshold;
detect when the cursor position is moving without a user moving the pointing device based on the determining; and
perform a cursor position reset operation in response to the detecting.

14. The apparatus of claim 13 wherein if changes in the position data meet the predefined human cursor movement threshold, the changes are deemed to be caused by a user.

15. The apparatus of claim 13 wherein, to perform cursor position reset operations, the one or more processors are operable to null the coordinate values.

16. The apparatus of claim 13 wherein the human cursor movement threshold is based on variations in a rate that the coordinate values change.

17. The apparatus of claim 13 wherein the human cursor movement threshold is based on variations in a rate that the coordinate values change, and wherein the human cursor movement threshold is not met if constant or low variations in the rate exist.

18. The apparatus of claim 13 wherein the human cursor movement threshold is based on variations in a rate that the coordinate values change, and wherein if the cursor position is changing at a constant rate for a predefined period of time, the cursor movement is deemed to be not caused by a user.

19. The apparatus of claim 13 wherein the human cursor movement threshold is based on variations in a rate that the coordinate values change, and wherein if the magnitude of the coordinate values remain constant for a predefined period of time, the cursor position is deemed to be moving without a user moving the pointing device.

20. The apparatus of claim 13 wherein, to perform a cursor position reset operation, processor nulls the coordinate values.

21. The apparatus of claim 13 wherein the cursor position reset operation is performed if the cursor position is deemed to be moving without a user moving the pointing device.

22. The apparatus of claim 13 wherein the one or more processors are operable to disable a cursor position reset operation when the cursor position moves without a user moving the pointing device.

23. The apparatus of claim 13 further comprising:
a controller coupled to the one or more processors; and
an analog-to-digital converter coupled to the controller and to the directional controller.

24. The apparatus of claim 13 wherein the directional controller comprises:
a plurality of differential amplifiers; and
a plurality of resistors coupled to the differential amplifiers.

25. An apparatus comprising:
a pointing device;
one or more processors; and
logic encoded in one or more tangible media for execution by the one or more processors and when executed operable to:
sample a cursor position;
store the cursor position to obtain position data;
iteratively repeat the sampling and storing cursor operations;
determine when changes in the position data meet a predefined human cursor movement threshold;
detect when the cursor position is moving with a user moving the pointing device based on the determining; and
disable cursor position reset operations in response to the detecting.

26. The apparatus of claim 25 wherein if changes in the position data meet the predefined human cursor movement threshold, the changes are deemed to be caused by a user.

27. The apparatus of claim 25 wherein, to determine when changes in the position data meet a predefined human cursor movement threshold, the one or more processors are operable to measure differences between absolute values of adjacent samples of the coordinate values.

28. The apparatus of claim 25 wherein, to determine when changes in the position data meet a predefined human cursor movement threshold, the one or more processors are operable to measure differences between absolute values of adjacent samples of the coordinate values, and wherein a user is deemed to be moving the pointing device differences between absolute values of adjacent samples of the coordinate values exist.

29. The apparatus of claim 25 wherein, to determine when changes in the position data meet a predefined human cursor movement threshold, the one or more processors are operable to measure a difference between an absolute value of at least one of the coordinate values and a predefined threshold value.

30. The apparatus of claim 25 wherein, to determine when changes in the position data meet a predefined human cursor movement threshold, the one or more processors are operable to measure a difference between an absolute value of at least one of the coordinate values and a predefined threshold value, wherein a user is deemed to be moving the pointing device if the measure absolute value of the at least one coordinate value is equal to or greater than the predefined human cursor movement threshold.

31. The apparatus of claim 25 wherein the one or more processors are operable to apply a cursor position reset operation to the coordinate values when a user is not moving the pointing device in order to cause the coordinate values to equal zero.

32. The apparatus of claim 25 further comprising:
a controller coupled to the one or more processors; and
an analog-to-digital converter coupled to the controller and to the directional controller.

33. The apparatus of claim 25 wherein the directional controller comprises:
a plurality of differential amplifiers; and
a plurality of resistors coupled to the differential amplifiers.
